(19) United States
(12) Patent Application Publication
(10) Pub. No.: US 2008/0058499 A1
(43) Pub. Date: Mar. 6, 2008

(54) Three-dimensional periodic structure, three-dimensional periodic porous structure, and method for producing these

(75) Inventors: Norimasa Fukazawa, Yotukaido-shi (JP); Ren-Hua Jin, Tokyo (JP)

Correspondence Address: KRATZ, QUINTOS & HANSON, LLP, 1420 K Street, N.W., Suite 400, WASHINGTON, DC, 20005, US

(73) Assignee: KAWAMURA INSTITUTE OF CHEMICAL RESEARCH, Sakura-shi (JP)

(21) Appl. No.: 11/882,912

(22) Filed: Aug. 7, 2007

Related U.S. Application Data
(62) Division of application No. 11/206,292, filed on Aug. 18, 2005.

(30) Foreign Application Priority Data
Oct. 13, 2004 (JP) 2004-298828

(51) Int. Cl. C08G 79/00

(52) U.S. Cl. 528/395

(57) ABSTRACT

The three-dimensional periodic structure of the present invention comprises a matrix made of an inorganic oxides in which core-shell particles are disposed so as to contact with each other, the core-shell particles each comprising a core portion made of a fine particle and a shell portion made of a crosslinked hydrophilic organic polymer backbones, wherein the hydrophilic organic polymer backbones and the inorganic oxides hybridize into an organic/inorganic a composite.

### CROSS REFERENCE TO RELATED APPLICATION

This is a Divisional application of U.S. patent application Ser. No. 11/206,292, filed on Aug. 18, 2005, which is hereby incorporated by reference.

### BACKGROUND OF THE INVENTION

1. Field of the Invention

The present invention relates to a three-dimensional periodic structure wherein fine particles are assembled into three-dimensional periodicity, a three-dimensional periodic porous structure wherein fine pores are arranged with three-dimensional periodicity, and a method for producing these.

2. Description of the Related Art

In recent years, materials having a three-dimensional periodic structure have been attracted as promising industrial materials used in wide range of fields, including optical materials, displays, catalysts, chemical separations and purifications, and paints. Particularly in the field of optical materials, a material referred to as a “photonic crystal (PC)” having a novel function of controlling light propagation has been at the focus of much attention. Inside of a material having a periodic structure, propagation of light is prohibited for the particular wavelength which is determined depending on the refractive index and the period of the material, and a band gap of light propagation which appears through this mechanism is referred to as a “photonic band gap (PBG)”. A dielectric multilayer having periodic refractive index with a period on the order of the wavelength of light, for example, is known to show excellent characteristic as a high efficiency mirror, and this structure is referred to as a “one-dimensional photonic crystal”. Structures having two-dimensional or three-dimensional periodicity in the refractive index which has a period on the order of the wavelength of light (hereinafter, such a structure is referred to as a “three-dimensional periodic structure”) make a two-dimensional or three-dimensional photonic crystal, respectively. Since these materials enable it to control the propagation of light in particular directions, they are believed to be applicable to optical waveguides and optical filters, optical integrated circuits, low-threshold lasers and other applications. Application to a structural color materials is also contemplated by utilizing the characteristic of intense light reflection of a particular wavelength.

For the purpose of making a three-dimensional periodic structure in refractive index, there have been already proposed several methods; for example, a method in which two-dimensional periodic structures were made in semiconductors or thin film of dielectric materials by electron beam lithography, etching, photolithography or other technology, and by repeating this procedure, the material of two-dimensional periodic structures were stacked in layers, a method of assembling fine particles of polystyrene, silica or the like, or a method of filling organic or inorganic materials into the space between assembled fine particles.

As the method of forming two-dimensional structures and stacking these in layers, for example, a method of producing a three-dimensional periodic structure having a period of about 1 μm or smaller by means of stacking a material on a substrate having a two-dimensional periodic structure and carrying out partial etching repeatedly (see, for example, Japanese Unexamined Patent Application, First Publication No. H10-335758), and a method of forming a stripe pattern on a substrate, stacking and combining another so that the stripes cross each other and selectively etching only the substrate so as to form a three-dimensional periodic structure of grating configuration (see, for example, S. Noda et al., Japanese Journal of Applied Physics; Part 2, Vol. 35, No. 7B, 1996; L909-912) are known. However, these methods require a number of very complicated operation steps and have difficulty in forming a multilayer structure. In the case of the latter method, to form a material having fine three-dimensional periodic structure capable of controlling light in a visible or near infrared region requires it to use a narrow pattern of stripes, which makes it difficult to achieve the required accuracy of the periodicity of the forming pattern and the accuracy of the position alignment for combining the stripes. As a result, it is difficult to make a structure having a fine three-dimensional periodic structure, particularly a structure having a periodic structure of a period on the order of several tens to several hundreds of nanometers.

As a method for forming a periodic structure of a period on the order of several tens to several hundreds of nanometers through a simpler way, it has been proposed to assemble fine uniform size particles of the order of several tens to several hundreds of nanometers. For example, as the three-dimensional periodic structure, there have been proposed structures obtained by a method which utilizes the sedimentation of fine particles (for example, described in R. Mayoral, et al., Advanced Materials, Vol. 9, No. 3, 1997; pp. 257-260), a method which utilizes the evaporation of solvent (for example, described in P. Jiang, et al, Chemistry of Materials, Vol. 11, No. 8, 1999; pp. 2132-2140), and a method of vertically pulling up a substrate dipped in a solution which contains fine particles dispersed therein, so as to form a single-layer film of fine particles through convective flow of solvent (see, for example, Japanese Unexamined Patent Application First Publication No. H08-234007). However, these methods involve such problems as a long period of time is required to make the three-dimensional periodic structure, and precise control of preparation condition, e.g., the temperature and atmosphere, is required so as to control the evaporation rate of the solvent, thus making the producing process complicated. Moreover, the structures obtained through these methods have such a structure as the particles are so closely packed that there is no space for accommodating a binding component which holds the particles bound together and maintains the structure, thus resulting in poor structural stability. These problems become more conspicuous as the structure increases in size, thus making it difficult to form the three-dimensional periodic structure throughout the entire structure.

When a periodic structure is used as optical materials such as a photonic crystal or color materials, it is more advantageous that the difference of the refractive indices between the materials which constitute the periodic structures is large, since it results in greater optical effect. As a method to differentiate the refractive index, it has been proposed to use a colloidal crystal, prepared by one of the methods described above, as a template (mold) to be filled with organic or inorganic materials in the space between the particles thereof, and remove the particles which has been used as the mold, thereby to form the so-called “inverse opal structure” wherein voids are arranged in a periodic arrangement. It is more preferable to form the three-dimensional periodic structure from inorganic materials, from the view point of stability. As the method to make this structure, there are disclosed a method of making a colloidal crystal through suction filtration of a solution containing fine particles of polystyrene suspended therein, adding dropwise a solution of a metal alkoxide onto the colloidal crystal so that the solution infiltrates between the fine particles, sintering this material so as to form a continuous structure of a metal oxide which fills the space between the fine particles, and removing the polystyrene thereby to form an inverse opal structure (see, for example, Brian T. Holland et al, Science, Vol. 281, 1998; pp. 538-540), a method of crushing a colloidal crystal, which has been made through sedimentation and orderly arrangement of a colloid dispersion containing polymer fine particles by a centrifugation method, into a powder, adding dropwise a solution of a metal alkoxide onto the powder so that the solution infiltrates between the fine particles, sintering this material so as to form a continuous structure of a metal oxide which fills the space between the fine particles, and removing the polymer thereby to form an inverse opal structure (for example, Herman Miguez et al, Advanced Materials, Vol. 13, No. 21, 2001; pp. 1634-1637), a method of filling the space, formed between the fine particles of a colloidal crystal made by a sedimentation method, with germanium by CVD (see, for example, Herman Miguez et al, Advanced Materials, Vol. 13, No. 21, 2001; pp. 1634-1637), and a method of filling the space between particles of a colloidal crystal formed on an electrode substrate with a metal in an electrochemical process, and apply a heat treatment or an acid treatment thereby to form an inverse opal structure (see, for example, Japanese Unexamined Patent Application, First Publication No. 2000-233998). With the methods described above, however, it is necessary to obtain colloidal crystals of high quality before synthesizing the inverse opal structure, and it is difficult to prepare a high quality colloidal crystal. In these methods, it takes quite long period of time to obtain colloidal crystals which will be infiltrated with organic or inorganic materials and be sintered. Furthermore, since the spaces between closely packed particles are so small that the filling organic or inorganic materials becomes unable to infiltrate further when the spaces near the surface are filled with. This results in inhomogeneous periodic structure. Moreover, since excess inorganic materials which have not infiltrated into the spaces of colloidal crystal forms a continuous body without a periodic structure, the material becomes inhomogeneous as portions which have a periodic structure and portions which do not have a periodic structure are intermingled. Also because the portions having a three-dimensional periodic structure of an inverse opal structure is formed by using a colloidal crystal mold constituted from simple particles which make contact with each other, this results in a weak structure where pores are connected at the contact points. This structure is difficult to maintain since it tends to be cracked when sintered, and it is likely to be eroded by chemicals such as alkali. It takes a very long period of time and elaborate operations to remove only those portions which do not have a periodic structure from this inorganic material made in this way, thus facing a hurdle in putting the method in practical application.

An object to be achieved by the present invention is to provide a three-dimensional periodic structure wherein fine particles are assembled into a uniform three-dimensional periodic structure which can be maintained stably, a three-dimensional periodic porous structure which o has a robust structure, and simple methods for producing these structures.

### SUMMARY OF THE INVENTION

According to the present invention, when a structure comprising core-shell particles comprising a core portion made of a fine particles and a shell portion made of a crosslinked hydrophilic polymer backbones, which are disposed in a periodic arrangement while making contact with each other, is fixed by inorganic oxides, it is made possible to obtain a three-dimensional periodic structure wherein the shell portion having a predetermined thickness forms a composite material with the inorganic oxides and the core portion is disposed in a periodic arrangement at the distance of the shell portion from each other.

Furthermore, when the fine particles are removed from the three-dimensional periodic structure, it is made possible to obtain a porous structure having a robust structure wherein fine pores are disposed in an orderly arrangement with three-dimensional periodicity and inorganic oxides or composite materials of inorganic oxides and hydrophilic organic polymer backbones fills the fine pores.

Furthermore, the three-dimensional periodic structure described above can be easily made by adding metal alkoxides to a dispersion, which is prepared by dispersing core-shell particles comprising a core portion made of a fine particles and a shell portion made of a crosslinked hydrophilic organic polymer backbones in an aqueous solvent thereby to cause a sol-gel reaction of the metal alkoxides and a three-dimensional periodic porous structure having an inverse opal structure can be easily made by eluting or sintering the core portion of the resulting structure.

Thus, the present invention provides a three-dimensional periodic structure comprising a matrix made of inorganic oxides in which core-shell particles comprising a core portion made of a fine particle and a shell portion made of a crosslinked hydrophilic polymer backbones are disposed so as to contact with each other, wherein the hydrophilic organic polymer backbones and the inorganic oxides form a composite domain, and also provides a three-dimensional periodic porous structure made by removing the core portion from the three-dimensional periodic structure.

Also the present invention provides a method for producing a three-dimensional periodic structure, which comprises the steps of dispersing core-shell particles comprising a core portion made of a fine particle and a shell portion made of a crosslinked hydrophilic organic polymer backbones in an aqueous solvent, and adding metal alkoxides to the dispersion thereby to cause a sol-gel reaction of the metal alkoxides producing a structure in which the fine particles of the core portions are arranged with three-dimensional periodicity in a composite material comprising the crosslinked hydrophilic organic polymer backbones and inorganic oxides produced by the sol-gel reaction of the metal alkoxides, which are integrated with each other, and also provide a method for producing a three-dimensional periodic structure, which comprises the step of removing the core portion from the three-dimensional periodic structure obtained by the method described above.

The three-dimensional periodic structure of the present invention has a robust and stable structure because fine particles are arranged with three-dimensional periodicity in the organic/inorganic hybrid comprising the crosslinked hydrophilic organic polymer backbones and the inorganic oxides produced by the sol-gel reaction of the metal alkoxides, which are integrated with each other. This structure is also less likely to experience cracks or disturbance of periodicity even when it is made large in size. It is easy to control the three-dimensional periodic structure by adjusting the particle size of the core portion and the thickness of the shell layer, and a proper material can be selected and used, and therefore the structure can be easily designed in accordance to the application. The three-dimensional periodic structure having such a feature can be advantageously used as an optical material.

The three-dimensional periodic structure which has high chemical resistance and uniform periodic structure throughout the entire structure having a stable and robust structure can be made by using fine particles made of a material which can be removed by dissolving in a solvent or sintering, and forming a three-dimensional periodic porous structure having independent fine pores disposed in three-dimensional periodicity by removing the core portion. The structure is less likely to experience cracks or disturbance of periodicity even when it is made large in size. Also because the pore size and distance between pores can be easily controlled, it is easy to control the three-dimensional periodic structure and, because a proper material can be selected and used, the structure can be easily designed in accordance to the application. The three-dimensional periodic porous structure having such a feature can be advantageously used as an optical material such as photonic crystal or color materials.

With the method of the present invention, since the dispersion of core-shell particles which have the shell portion prepared in the state of gel containing the aqueous solvent is used, it has sufficient fluidity even when the particles are contained in high concentration, making it easier to be introduced into various vessels and coated onto a substrate. It is also made easy to form a periodic structure with a constant distance corresponding to the thickness of the shell portion. The distance between the core particles can also be controlled by adjusting the thickness of the shell portion. Use of the shell portion prepared in the state of gel containing the aqueous solvent also makes it possible to fill the space between the particles with organic or inorganic materials easily and uniformly.

### BRIEF DESCRIPTION OF THE DRAWINGS

FIG. 1 is an electron microscope photograph of the surface of the three-dimensional periodic structure obtained in Example 1.

FIG. 2 is an electron microscope photograph of the surface of a three-dimensional periodic structure obtained in Example 4.

FIG. 3 is an electron microscope photograph of the surface of a three-dimensional periodic porous structure obtained in Example 7.

FIG. 4 is an electron microscope photograph of the surface of a three-dimensional periodic structure obtained in Example 8.

FIG. 5 is an electron microscope photograph of the surface of a three-dimensional periodic porous structure obtained in Example 8.

FIG. 6 is an electron microscope photograph (magnified by 50,000 times) of a cross-section of a film made of an inorganic oxide periodic structure obtained in Example 9.

FIG. 7 is an electron microscope photograph (magnified by 10,000 times) of a cross-section of a film made of an inorganic oxide periodic structure obtained in Example 9.

FIG. 8 is an electron microscope photograph (magnified by 50,000 times) of a cross-section of a film made of an inorganic oxide periodic structure obtained in Example 10.

FIG. 9 is an electron microscope photograph (magnified by 10,000 times) of a cross-section of a film made of an inorganic oxide periodic structure obtained in Example 10.

FIG. 10 is an electron microscope photograph (magnified by 25,000 times) of a cross-section of a film made of an inorganic oxide periodic structure obtained in Example 14.

FIG. 11 is an electron microscope photograph (magnified by 50,000 times) of a cross-section of a film made of an inorganic oxide obtained in Comparative Example 1.

FIG. 12 is an electron microscope photograph (magnified by 10,000 times) of a cross-section of a film made of an inorganic oxide obtained in Comparative Example 1.

FIG. 13 is an electron microscope photograph (magnified by 50,000 times) of a cross-section of a film made of an inorganic oxide obtained in Comparative Example 1.

FIG. 14 is an electron microscope photograph (magnified by 50,000 times) of a cross-section of a film made of an inorganic oxide obtained in Comparative Example 1.

FIG. 15 is an electron microscope photograph (magnified by 50,000 times) of a cross-section of a film made of an inorganic oxide obtained in Comparative Example 2.

FIG. 16 is an electron microscope photograph (magnified by 25,000 times) of a cross-section of a film made of an inorganic oxide in periodic structure obtained in Comparative Example 2.

FIG. 17 is an electron microscope photograph (magnified by 25,000 times) of a cross-section of a film made of an inorganic oxide in periodic structure obtained in Comparative Example 2.

### DETAILED DESCRIPTION OF THE INVENTION

The three-dimensional periodic structure of the present invention comprises a matrix made of an inorganic oxide in which core-shell particles are disposed so as to contact with each other, the core-shell particles each comprising a core portion made of a fine particle and a shell portion made of a crosslinked hydrophilic organic polymer compound, wherein the hydrophilic organic polymer compound and the inorganic oxide form a composite material.

The inorganic oxide used in the present invention includes, for example, an inorganic oxide obtained by the sol-gel reaction of a metal alkoxide, and specific examples thereof include inorganic oxides obtained by the sol-gel reaction of alkoxides of metals or metalloids such as aluminum, silicon, boron, titanium, vanadium, manganese, iron, cobalt, zinc, germanium, yttrium, zirconium, niobium, cadmium, and tantalum. Examples of the alkoxide include, but are not limited to, methoxide, ethoxide, propoxide, isopropoxide, and butoxide; and alkoxide derivatives obtained by substituting a portion of alkoxy groups with β-diketone, β-ketoester, alkanolamine, or alkylalkanolamine. These metal alkoxides may be used alone or in combination thereof. The alkoxide of silicon can be preferably used in the present invention because it is easy to handle. Metals such as titanium and zirconium, in which a metal oxide formed from the alkoxide has a refractive index of more than 2, are preferable because excellent effect as an optical material is exerted.

In the present invention, since core-shell particles comprising a core portion made of a fine particles and a shell portion made of a crosslinked hydrophilic polymer compound are disposed while making contact with each other, the core portion is disposed in a periodic arrangement at the distance of the shell portion having a predetermined thickness from each other.

The fine particles constituting the core portion of the core-shell particles are not specifically limited as far as they are not eluted in an aqueous solvent and can comprise a shell layer made of the following hydrophilic organic polymer compound and, for example, organic polymer compounds and inorganic compounds such as metal and inorganic oxide can be used. It is preferred that the fine particles can be easily eluted from the three-dimensional periodic structure using a solvent. The fine particles preferably have a spherical shape and fine particles whose profile having an elliptic or array shape can also be used. Herein, various fine particles having different shapes are simply referred to as particles.

The organic polymer compound which can be used as fine particles constituting the core portion includes, for example, a polymer of an ethylenically unsaturated monomer, and specific examples thereof include organic polymers obtained by polymerizing one or more kinds of monovinyl aromatic hydrocarbons such as styrene, 4-methoxystyrene, α-methylstyrene, vinyltoluene, α-chlorostyrene, o-, m- or p-chlorostyrene, p-ethylstyrene and vinylnaphthalene, and acrylic monomers such as methacrylic acid, methyl acrylate, ethyl acrylate, butyl acrylate, 2-ethylhexyl acrylate, cyclohexyl acrylate, phenyl acrylate, methacrylic acid, methyl methacrylate, ethyl methacrylate, propyl methacrylate, butyl methacrylate, hexyl methacrylate and 2-ethylhexyl methacrylate, or copolymerizing two or more kinds of them.

Also there can be used copolymers of the ethylenically unsaturated monomer described above and acrylamide type monomers such as acrylamide, N-methylacrylamide, N-ethylacrylamide, N-cyclopropylacrylamide, N-isopropylacrylamide, methacrylamide, N-methylmethacrylamide, N-cyclopropylmethacrylamide, N-isopropylmethacrylamide, N,N-dimethylacrylamide, N-methyl-N-ethylacrylamide, N-methyl-N-isopropylacrylamide, N-methyl-N-n-propylacrylamide, N,N-diethylacrylamide, N-ethyl-N-isopropylacrylamide, N-ethyl-N-n-propylacrylamide, N,N-diisopropylacrylamide, N-acryloyl pyrrolidone, N-acryloylpiperidone, N-acryloylmethylhomopiperazine and N-acryloylmethylpiperazine. When a copolymer of the acrylamide type monomer is used, the content of the acrylamide type monomer is preferably 30% by weight or less.

It is particularly preferred to use styrene, a (meth)acrylate and a styrene/acrylamide type monomer because particles having a uniform particle size with a narrow particle size distribution can be easily prepared.

Examples of the inorganic compound, which can be used as fine particles constituting the core portion, include metals such as Ni, Cu, Ag, Pt and Au; and inorganic oxides such as silica, alumina, titania and zirconia. As the inorganic compound, commercially available inorganic compounds may be used and also inorganic compounds prepared by various known methods may be used. Particles made of silicon dioxide can be preferably used because they can be easily formed into particles.

The hydrophilic organic polymer compound constituting the shell portion of the core-shell particles is not specifically limited as far as it can form a crosslinked compound and also form a gel with an aqueous solvent and, for example, there can be used crosslinked compounds obtained by polymerizing at least one selected from among acrylamide type monomers such as acrylamide, N-methylacrylamide, N-ethylacrylamide, N-cyclopropylacrylamide, N-isopropylacrylamide, N-n-propylacrylamide, methacrylamide, N-methylmethacrylamide, N-cyclopropylmethacrylamide, N-isopropylmethacrylamide, N,N-dimethylacrylamide, N-methyl-N-ethylacrylamide, N-methyl-N-isopropylacrylamide, N-methyl-N-n-propylacrylamide, N,N-diethylacrylamide, N-ethyl-N-isopropylacrylamide, N-ethyl-N-n-propylacrylamide, N,N-diisopropylacrylamide, N-acryloylpyrrolidone, N-acryloylpiperidone, N-acryloylmethylhomopiperazine and N-acryloylmethylpiperazine, or polymerizing two or more kinds of them. Also those obtained by copolymerizing them with acrylic acid, methacrylamide-propyl-trimethyl-ammoniumchloride, 1-vinylimidazole and methacryloyloxyphenyldimethylsulfonium methylsulfate. As a crosslinking agent used to crosslink them, conventionally known crosslinking agents such as N,N′-methylenebisacrylamide and ethylene glycol dimethacrylate can be used.

In the three-dimensional periodic structure of the present invention, a composite material is formed of compositing of the hydrophilic organic polymer compound constituting the shell portion of the core-shell particles and the inorganic oxide constituting the matrix. As used herein, the term “compositing” refers to the state where direct reaction between the crosslinked hydrophilic organic polymer compound and the inorganic oxide does not substantially arise and the both are integrated by forming the inorganic oxide in a crosslinked structure of the crosslinked hydrophilic organic polymer compound.

When the inorganic oxide is obtained by the sol-gel reaction of the metal alkoxide, the sol-gel reaction of the metal alkoxide proceeds in the crosslinked structure of the crosslinked hydrophilic organic polymer compound constituting the shell portion of adjacently arranged core-shell particles, and thus the crosslinked hydrophilic organic polymer compound and the inorganic oxide are integrated in the crosslinked compound portion of the hydrophilic organic polymer compound constituting the shell portion. In this case, since the inorganic oxide does not react in an independent state between adjacent core-shell particles but is continuous, the inorganic oxide forms an integrated continuous matrix and fixes adjacently arranged core-shell particles and also forms an external shape of a structure. Consequently, there is obtained a three-dimensional periodic structure comprising a matrix made of the inorganic oxide in which core-shell particles are disposed so as to contact with each other, and the hydrophilic organic polymer compound constituting the shell portion and the inorganic oxide form a composite material.

Since fine particles include a crosslinked compound portion having a predetermined thickness of the hydrophilic organic polymer compound around the fine particles, the three-dimensional periodic structure of the present invention is formed by arranging the respective fine particles via the crosslinked compound portion. As described above, when this crosslinked compound portion is combined and fixed with the inorganic oxide obtained by the sol-gel reaction of the metal alkoxide, it is made possible to obtain a structure wherein fine particles are arranged with three-dimensional periodicity via a composited portion having a predetermined thickness.

When fine particles arranged in the three-dimensional periodic structure of the present invention have a spherical shape, the particle size is preferably within a range from 20 nm to 10 μm. Particularly, in case of making a photonic crystal, the particle size is preferably within a range from 50 nm to 5 μm. In case of making a photonic crystal or structural color material which exhibits a function in a visible or near infrared region, the particle size is particularly preferably within a range from 200 nm to 900 nm.

The fine particles arranged in the three-dimensional periodic structure independently exist and the thickness of the structure on a line connecting the centers of adjacent fine particles is preferably within a range from 5 nm to 10 μm, and particularly preferably from 10 nm to 2 μm in view of stability and ease of fabrication of the structure.

The distance between fine particles arranged with three-dimensional periodicity may be appropriately selected according to the particle size of fine particles and the center-distance between adjacent fine particles is preferably within a range from 25 nm to 20 μm. In case of using as a photonic crystal or structural color developing material which exhibits a function in a visible or near infrared region, the center-distance between adjacent fine particles is particularly within a range from 100 nm to 1000 nm.

Since a binding component comprising a crosslinked hydrophilic organic polymer compound and an inorganic oxide exists between fine particles, the three-dimensional periodic structure of the present invention is excellent in stability of the structure because the entire structure has a firm structure as compared with a structure in which the inorganic oxide is formed in the space packed closely with conventional particles. Consequently, a large-sized three-dimensional periodic structure can be made.

The three-dimensional periodic porous structure of the present invention is obtained by removing the core portion in the three-dimensional periodic structure and is a structure in which independent pores are arranged with three-dimensional periodicity. The structure may be composed of an inorganic oxide, or a composite material made of a crosslinked hydrophilic organic polymer compound and an inorganic oxide. Alternatively, the surface of the inorganic oxide may contain one or more metals or metal ions.

When only fine particles of the core portion are removed, there can be obtained a three-dimensional periodic porous structure in which pores are arranged with three-dimensional periodicity in a structure wherein a matrix composed of an inorganic oxide forms a composite with a crosslinked hydrophilic organic polymer compound. When the crosslinked hydrophilic organic polymer compound is removed together with the core portion, there can be obtained a three-dimensional periodic porous structure in which pores are arranged with three-dimensional periodicity in a structure composed of an inorganic oxide. In both cases, since pores are arranged at the distance in the structure according to the thickness of a crosslinked hydrophilic organic polymer compound which constitutes a shell layer of core-shell particles, there can be obtained a structure which is firm as compared with a periodic structure including connecting pores.

The pore size of pores arranged in the three-dimensional periodic porous structure of the present invention is preferably within a range from 20 nm to 10 μm, and more preferably from 50 nm to 5 μm in view of simplicity of preparation. The pores arranged in the three-dimensional periodic porous structure of the present invention have such distinctive feature that they independently exit and the thickness of the inorganic oxide on a line connecting the centers of adjacent pores is preferably within a range from 5 nm to 10 μm, and is particularly preferably from 10 nm to 2 μm in view of stability of the structure and ease of preparation.

In the three-dimensional periodic porous structure of the present invention, the distance between pores arranged with three-dimensional periodicity may be appropriately selected according to the purposes and the center-distance of adjacent pores among pores, which exist independently, is preferably within a range from 25 nm to 20 μm. When used as a photonic crystal or structural color developing material which functions in a visible or near infrared region, the center-distance of adjacent pores is particularly preferably within a range from 100 nm to 1000 nm.

In the three-dimensional periodic porous structure of the present invention, since pores arranged with three-dimensional periodicity independently exist and pores are not connected with each other, it is less likely to be eroded by chemicals such as alkali, and thus a three-dimensional periodic porous structure having excellent chemical resistance can be formed.

The three-dimensional periodic porous structure obtained in the present invention has such a structure that arranged core-shell particles comprising a shell portion made of a crosslinked hydrophilic organic polymer compound and the crosslinked hydrophilic organic polymer compound are integrated through an inorganic oxide produced by the sol-gel reaction of a metal alkoxide, and thus the three-dimensional periodic structure of the fine particles can be stably maintained. Since the three-dimensional periodic structure is sintered, there can be made a large-sized three-dimensional periodic porous structure which has sufficient structural stability even if the size of the structure increases.

The oxide inorganic periodic structure can be preferably used as a color developing material or a photonic crystal because it is excellent in chemical resistance and structural stability and can increases a difference in refractive index between the pore portion and the structural portion made of the inorganic oxide.

The three-dimensional periodic structure of the present invention can be preferably prepared by a method which comprises the steps of: (1) dispersing core-shell particles in an aqueous solvent to obtain a dispersion, the core-shell particles each comprising a core portion made of a fine particle and a shell portion made of a crosslinked hydrophilic organic polymer compound, and (2) adding a metal alkoxide to the dispersion thereby to cause the metal alkoxide to undergo a sol-gel reaction to form an inorganic oxide matrix by the sol-gel reaction with the metal alkoxide and a composite material of an inorganic oxide and the crosslinked hydrophilic organic polymer compound, and thus obtaining a structure having such a structure that core-shell particles are contacted with each other in an inorganic oxide matrix.

In the method of the present invention, first, in the process where an aqueous solvent is contacted with a metal alkoxide to cause the reaction and the product is gradually incorporated into the gel-like shell portion obtained by absorption of the aqueous solvent, the core-shell particles are gradually sedimented. In this case, it is considered that individual core-shell particles are separately sedimented and precipitation under mild conditions, which cannot be obtained unless a dispersion solvent must be gradually vaporized under controlled conditions. Therefore, it is considered that the sedimented core-shell particles are closely packed. In the state where core-shell particles are closely packed and are adjacent with each other, the sol-gel reaction proceeds even at the space formed by adjacent core-shell particles to form a matrix made of continuously integrated inorganic oxide, and also the inorganic oxide and the shell portion of core-shell particles form a composite material, and thus arrangement of the core-shell particles is stabilized and a three-dimensional periodic structure is formed.

The organic polymer compound used for core particles of the core-shell particles in the step (1) is not specifically limited as far as monodispersed fine particles can be prepared, and those described above can be used. As the hydrophilic organic polymer compound constituting the shell layer of the core-shell particles, there can also be used those described above.

When both core and shell portions are made of the polymer compound, core-shell particles used in the step (1) can be prepared by various known methods such as microgel method, emulsion polymerization method, soap-free emulsion polymerization method, seed emulsion polymerization method, two-stage swelling method, dispersion polymerization method, and suspension polymerization method. The core and shell portions may be continuously prepared. Alternatively, after previously preparing particles constituting the core portion, the shell portion may be separately prepared using the resulting particles as a seed. Also commercially available particles can be used as core particles.

Since the size of the core portion and the thickness of the shell portion can be adjusted in case of preparing the core-shell particles, the size of fine particles in the three-dimensional periodic structure obtained in the step (2) and the distance between particles can be easily controlled. Consequently, the diameter of pores arranged with three-dimensional periodicity, the thickness of an inorganic oxide on a line connecting the centers of adjacent pores, and the center-distance of adjacent pores among pores arranged in a matrix of the inorganic oxide can be easily controlled in the three-dimensional periodic porous structure.

In the core-shell particles, the core portion and the shell portion each may be independently neutral or has positive or negative charges. The core portion of the core-shell particles (A) can be easily charged by selecting a polymerization initiator for preparation of the core portion when the core portion is made of an organic polymer. For example, when V-50 (manufactured by Wako Pure Chemical Industries, Ltd.) is used as the polymerization initiator made of an organic polymer constituting particles, the particles has positive charges. When potassium persulfate (KPS(K₂S₂O₈)) is used, the surfaces of the particles have negative charges. Charging of the shell portion can also be used by selecting the polymerization initiator.

To form the three-dimensional periodic structure of the present invention, variation in particle size of the core-shell particles must be decreased. The particle size of the core-shell particles is preferably a particle size in which the degree of variation represented by (standard deviation of particle size)/(average particle size) is 0.25 or less in the state where a hydrophilic solvent is removed. The degree of variation is more preferably 0.2 or less, and still more preferably 0.1 or less. In case of preparing a photonic crystal, the smaller the variation, the better.

The dispersion used in the step (1) can be obtained by dispersing the core-shell particles in an aqueous solvent. The dispersion in the present invention is a dispersion in which the core-shell particles are nearly regularly arranged in the aqueous solvent to form a sol by dispersing the core-shell particles in the aqueous solvent, and also a colloidal crystal is at least locally formed.

As used herein, the term “aqueous solvent” refers to water or a solvent mixture of water and a hydrophilic solvent, and alcoholic hydrophilic solvents such as methanol and ethanol can be used as the hydrophilic solvent. The dispersion may be used after concentrating or diluting a dispersion prepared by dispersing previously prepared core-shell particles in a hydrophilic solvent, but a dispersion obtained by concentrating a dispersion in case of preparing core-shell particles by a method for preparing the core-shell particles may also be used. The concentration of the core-shell particles in the dispersion is preferably from 30 to 60% by weight when the thickness of the shell portion is ⅕ or less of the core particle size, and is preferably from 15 to 60% by weight when the thickness of the shell portion is more than ⅕ of the core particle size.

The metal alkoxide used in the step (2) may be a metal alkoxide which can give the inorganic oxide described above and, for example, there can be used at least one of alkoxides of metals or metalloids, such as aluminum, silicon, boron, titanium, vanadium, manganese, iron, cobalt, zinc, germanium, yttrium, zirconium, niobium, cadmium, and tantalum. Examples of the alkoxide include, but are not limited to, methoxide, ethoxide, propoxide, isopropoxide, and butoxide, and also may include alkoxide derivatives in which a portion of alkoxy group is substituted with β-diketone, β-ketoesters, alkanolamine, or alkylalkanolamine. These metal alkoxides may be used alone or in combination.

In the step (2), the term “compositing” of a matrix of an inorganic oxide produced by the sol-gel reaction of a metal alkoxide and a crosslinked hydrophilic polymer compound refers to the state where direct reaction between the inorganic oxide and the crosslinked hydrophilic organic polymer compound does not substantially arise and the both are integrated by forming the inorganic oxide in a crosslinked structure of the crosslinked hydrophilic organic polymer compound, as described above.

In the step (2), the sol-gel reaction of the metal alkoxide proceeds in the crosslinked structure of the crosslinked hydrophilic organic polymer compound constituting the shell portion of adjacently arranged core-shell particles, and thus the crosslinked hydrophilic organic polymer compound and the inorganic oxide are integrated in the crosslinked compound portion of the hydrophilic organic polymer compound constituting the core portion. In this case, since the inorganic oxide does not react in an independent state between adjacent core-shell particles but is continuous, the inorganic oxide forms an integrated continuous matrix and fixes adjacently arranged core-shell particles and also forms an external shape of a structure. Consequently, there is obtained a three-dimensional periodic structure comprising a matrix made of the inorganic oxide in which core-shell particles are disposed so as to contact with each other, and the hydrophilic organic polymer compound constituting the shell portion and the inorganic oxide form a composite material.

In the step (2), when plural core-shell particles having less variation are adjacent, the predetermined distance between core particles according to the thickness of the shell portion can be maintained due to the presence of the shell portion. In the method of the present invention, when a metal alkoxide is added to a dispersion prepared by dispersing core-shell particles in an aqueous solvent, the metal alkoxide contacts with a hydrophilic solvent and is incorporated into the gel-like shell portion produced as a result of hydrolysis or alcohol decomposition, and also the metal alkoxide is dispersed into the entire dispersion. In this case, the sol-gel reaction proceeds to form a matrix of an inorganic oxide. Furthermore, the sol-gel reaction proceeds in the shell portion and therefore a crosslinked hydrophilic organic polymer compound and an inorganic oxide are integrated to form a composite material and to form a structure in which core-shell particles are contacted with each other in a matrix of an inorganic oxide, and thus making a three-dimensional periodic structure in which fine particles of the core portion are arranged with fixed periodicity.

Although the core-shell particles in the dispersion are arranged with a periodic structure when the sol-gel reaction is conducted by adding the metal alkoxide in the step (2), the step of previously arranging the core-shell particles may be included. Since the core-shell particles are easily arranged by concentration, more homogeneous periodic structure can be obtained by including the step of concentrating a dispersion after the step (1). Therefore, the core-shell particles in the dispersion are preferably arranged using various methods of concentrating the dispersion. For example, the core-shell particles can be arranged by concentrating the dispersion of the core-shell particles using a centrifugal separator. The core-shell particles can be arranged by concentrating the dispersion while air-drying or vacuum-drying the dispersion in any vessel. When using in the state where the dispersion is filtered with a membrane filter and the filtrate on the filter is not completely dried, core-shell particles comprising a shell portion made of a hydrophilic organic polymer gel are adjacently arranged and therefore a metal alkoxide may be added thereto.

Since the metal alkoxide added in the step (2) causes the sol-gel reaction with an aqueous solvent between core-shell particles to form an inorganic oxide and the inorganic oxide firmly bonds the space between core-shell particles, the resulting three-dimensional periodic structure has a firm structure. Therefore, even if the distance between particles is large, there can be made a three-dimensional periodic structure in which fine particles constituting the core portion having sufficient strength are arranged.

When the shell portion has a large thickness which is about 1 to 2 times as the core particle size, when plural core-shell particles are adjacent, the shell portion functions as a cushion and deforms, and thus the space between core-shell particles can be filled with the gel-like shell portion. In this case, there can be formed a three-dimensional periodic structure in which the space between core particles is composed of a composite material of a hydrophilic organic polymer and an inorganic oxide converted from the metal alkoxide. The amount of the metal alkoxide to be added is preferably the same as or more than that of the dispersion of core-shell particles, and more preferably two times as that of the dispersion.

In the step (2), a metal alkoxide is added to a dispersion of core-shell particles and, after standing for about one hour to one week, the supernatant is removed and dried. Before drying, the sol-gel reaction may be allowed to further proceed under saturated steam conditions.

The metal alkoxide may be added by the following method. For example, a dispersion of core-shell particles is charged in any vessel and then the metal alkoxide is directly added, or the dispersion is applied onto a substrate and then the substrate is dipped in a vessel containing a metal alkoxide. As described above, the three-dimensional periodic porous structure of the present invention can be formed in any shape.

As described above, the method of the present invention is different from a conventional method of filling a small space, which is closely packed with particles, with a binding component, and the inorganic oxide is dispersed in the entire structure, and thus a three-dimensional periodic structure having a firm and stable structure can be easily formed.

Also a three-dimensional periodic porous structure in which pores are arranged with three-dimensional periodicity can be easily obtained by the method which comprises the steps of: (i) dispersing core-shell particles in an aqueous solvent to obtain a dispersion, the core-shell particles each comprising a core portion made of a fine particle and a shell portion made of a crosslinked hydrophilic organic polymer compound, (ii) adding a metal alkoxide to the dispersion thereby to cause the metal alkoxide to undergo a sol-gel reaction to form an inorganic oxide matrix by the sol-gel reaction with the metal alkoxide and a composite of an inorganic oxide and a crosslinked hydrophilic organic polymer compound, and thus obtaining a structure having such a structure that core-shell particles are contacted with each other in an inorganic oxide matrix, and (iii) removing the fine particles in the structure.

According to the method, an organic component is removed in the step (iii) after a three-dimensional periodic structure was obtained in the steps (i) and (ii) which are the same as the steps (1) and (2) of the above method. Examples of the method of removing fine particles include removal by sintering and removal by elution with a solvent. When fine particles are removed, the hydrophilic organic polymer compound constituting the shell portion of the core-shell particles may be simultaneously removed or remained.

In case of removing the organic component by sintering, the sintering temperature is preferably within a range from 600° C. to 1500° C., and is more preferably from 600° C. to 800° C. so as to prevent deformation of the structure while efficiently removing the organic component. The organic component is preferably removed by sintering because toughening of the inorganic oxide structure can be attained by sintering.

As the solvent in case of eluting an organic component with the solvent, when the core portion is made of a polymer of a monovinyl aromatic hydrocarbon, such as polystyrene, poly(4-methoxystyrene), poly(α-methylstyrene), poly(vinyltoluene) or poly(vinyl naphthalene), there can be used solvents such as benzene, toluene, cyclohexanone, ethyl acetate, 2-butanone, tetrahydrofuran, methylene chloride, and chloroform. When the core portion is made of fine particles of those obtained by polymerizing acrylates, such as poly(methyl acrylate), poly(ethyl acrylate) and poly(butyl acrylate), there can be used solvents such as acetone, benzene, dichloroethane, and dioxane. In case of polymer particles of methacrylates, such as poly(methyl methacrylate), poly(ethyl methacrylate), poly(propyl methacrylate) and poly(butyl methacrylate), there can be used acetone, ethyl acetate, toluene, benzene, 2-butanone, and tetrahydrofuran. Only fine particles of the core portion can be removed by appropriately selecting the solvent to be used.

As described above, according to the method of the present invention, the inorganic oxide exists in the entire structure via the shell portion, unlike a conventional method of filling less space packed closely with particles with a binding component, a three-dimensional periodic structure having a firm and stable structure can be easily obtained. Also it is possible to easily obtain a structure in which core particles do not contact with each other due to the inorganic oxide filled into the shell portion and independently exist. Also it is possible to easily form a three-dimensional periodic porous structure in which periodically arranged pores independently exist after removing an organic component.

### EXAMPLES

### Example 1

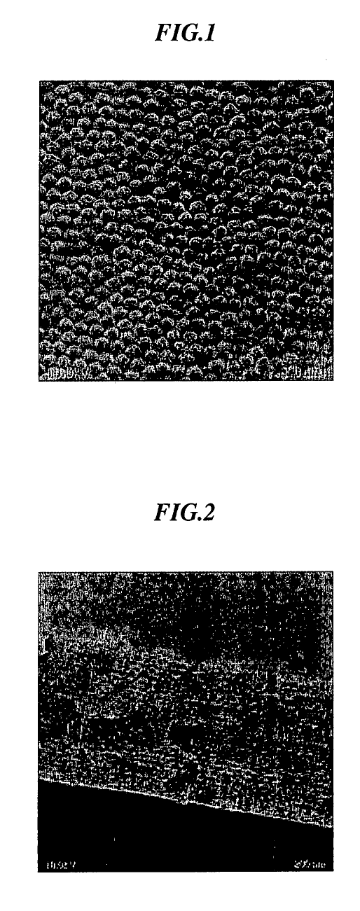

In 100 ml of water, 0.5 g of N-isopropylacrylamide and 3.5 g of styrene were added and core particles were prepared under a nitrogen gas flow at 70° C. using potassium persulfate (KPS(K₂S₂O₈)) as an initiator. Furthermore, 0.35 g of N-isopropylacrylamide, 0.03 g of N,N′-methylenebisacrylamide and 0.1 g of acrylic acid were added and a shell portion was formed using KPS as an initiator to prepare core-shell particles comprising a core portion made of polystyrene and a shell portion made of crosslinked poly(N-isopropylacrylamide)-acrylic acid. In the same manner as in Example 2, an average particle size was determined. The resulting particles showed a thickness of the shell portion in a state of being dispersed in water of about 10 nm and an average core particle size of 310 nm. 20 mg of a 40 wt % dispersion was applied onto the bottom of a sample bottle, followed by the addition of 0.1 ml of tetraethyl orthosilicate (tetraethoxysilane: TEOS) and further standing for 10 minutes. After removing the supernatant and drying for one day, a thin film of a three-dimensional periodic structure was formed on the bottom of the bottle. The resulting thin film showed an iridescence color. The resulting thin film was peeled off and the cross-section was observed by an electron microscope. As shown in FIG. 1, it was confirmed that the thin film is made of a three-dimensional periodic structure having an internal structure in which fine particles are periodically arranged.

### Example 2

In 100 ml of water, 0.95 g of N-isopropylacrylamide and 4.2 g of styrene were added and core particles were prepared under a nitrogen gas flow at 70° C. using potassium persulfate (KPS(K₂S₂O₈)) as an initiator. Furthermore, 1.48 g of N-isopropylacrylamide, 0.2 g of N,N′-methylenebisacrylamide and 0.3 g of acrylic acid were added and a shell portion was formed using KPS as an initiator to prepare core-shell particles comprising a core portion made of polystyrene and a shell portion made of crosslinked poly(N-isopropylacrylamide)-acrylic acid. An average particle size of the resulting core-shell particles was measured by a particle analyzer capable of measuring over a wide concentration range, “FPAR-1000” manufactured by Otsuka Electronics Co., Ltd. As a result, it was 490 nm. Variation in particle size was 10%. The particles were observed in a dry state using S-800 type ultra-high resolution scanning electron microscope. As a result, an average particle size was found to be 410 nm and an average thickness of the shell portion was found to be 40 nm.

20 mg of a dispersion (50 wt % water dispersion) of the resulting core-shell particles was applied onto the bottom of a sample bottle having an inner diameter of 25 mm, followed by the addition of 0.1 ml of tetraethyl orthosilicate (tetraethoxysilane: TEOS) and further standing for 30 minutes. After removing the supernatant and standing for one week while putting on a lid, the lid was taken off, followed by drying for one day to form a thin film of a three-dimensional periodic structure on the bottom of the bottle. The resulting thin film showed an iridescence color.

### Example 3

20 mg of a dispersion (50 wt % water dispersion) of the core-shell particles prepared in the same manner as in Example 2 was applied onto the bottom of a sample bottle having an inner diameter of 25 mm, followed by the addition of 0.1 ml of tetraethyl orthosilicate (tetraethoxysilane: TEOS) and further standing for 30 minutes. After standing for one week while putting on a lid, the lid was taken off, followed by drying for one day to form a thin film of a three-dimensional periodic structure on the bottom of the bottle. The resulting thin film showed an iridescence color.

### Example 4

In 100 ml of water, 0.5 g of N-isopropylacrylamide and 1.2 g of styrene were added and core particles were prepared under a nitrogen gas flow at 70° C. using potassium persulfate (KPS(K₂S₂O₈)) as an initiator. An average particle size of the resulting particles was measured by a particle analyzer capable of measuring over a wide concentration range, “FPAR-1000” manufactured by Otsuka Electronics Co., Ltd. As a result, it was 230 nm. Furthermore, 1.48 g of N-isopropylacrylamide, 0.2 g of N,N′-methylenebisacrylamide and 0.45 g of acrylic acid were added and a shell portion was formed using KPS as an initiator to prepare core-shell particles comprising a core portion made of polystyrene and a shell portion made of crosslinked poly(N-isopropylacrylamide)-acrylic acid.

In the same manner, an average particle size of the resulting core-shell particles (1) was measured by a particle analyzer capable of measuring over a wide concentration range, “FPAR-1000” manufactured by Otsuka Electronics Co., Ltd. As a result, an average particle size in a state of being dispersed in water was found to be 690 nm and an average thickness of the shell portion was found to be about 230 nm. 20 mg of a 16 wt % dispersion of the resulting core-shell particles was applied onto the bottom of a sample bottle, followed by the addition of 0.1 ml of tetraethyl orthosilicate (tetraethoxysilane: TEOS) and further standing for 10 minutes. After removing the supernatant and drying for one day, a thin film of a three-dimensional periodic structure was formed on the bottom of the bottle. The resulting thin film showed an iridescence color. The resulting thin film was peeled off and the cross-section was observed by an electron microscope. As shown in FIG. 2, it was confirmed that the thin film is made of a three-dimensional periodic structure having an internal structure in which fine particles are periodically arranged.

### Example 5

In 100 ml of water, 0.5 g of N-isopropylacrylamide and 1.1 g of styrene were added and core particles were prepared under a nitrogen gas flow at 70° C. using potassium persulfate (KPS(K₂S₂O₈)) as an initiator. Furthermore, 1.0 g of N-isopropylacrylamide and 0.1 g of N,N′-methylenebisacrylamide were added and a shell portion was formed using KPS as an initiator to prepare core-shell particles comprising a core portion made of polystyrene and a shell portion made of crosslinked poly(N-isopropylacrylamide)-acrylic acid. In the same manner as in Example 3, an average particle size was determined. As a result, the thickness of the shell portion in a state of being dispersed in water was about 100 nm and the spherical core particles had an average particle size of 200 nm. A 20 wt % dispersion was applied onto a glass substrate measuring 2.5 cm×2.5 cm using a spin coating method dipped in 9 ml of tetraethyl orthosilicate (tetraethoxysilane: TEOS) and then allowed to stand for 12 hours. The glass substrate was taken out and then dried to form a thin film of a three-dimensional periodic structure was formed on the surface of the glass substrate. The resulting thin film showed a pale blue interference color. The surface was observed by an electron microscope. As a result, it was confirmed that the thin film is made of a structure having an internal structure in which fine particles are periodically arranged.

### Example 6

In the same manner as in Example 5, a 20 wt % dispersion of core-shell particles comprising a core portion having a core diameter of about 200 nm made of polystyrene and a shell portion having a thickness of about 100 nm made of crosslinked poly(N-isopropylacrylamide) in a state of being dispersed in water was applied onto a glass substrate measuring 2.5 cm×2.5 cm using a spin coating method, dipped in 9 ml of tetraethyl orthosilicate (tetraethoxysilane: TEOS) and then allowed to stand for 12 hours. The glass substrate was taken out, dipped in tetramethyl orthosilicate (tetramethoxysilane: TMOS), allowed to stand for one hour and then dried to form a thin film of a three-dimensional periodic structure on the surface of the glass substrate. The resulting thin film showed a blue interference color. The surface was observed by an electron microscope. As a result, it was confirmed that the thin film is made of a structure having an internal structure in which fine particles are periodically arranged.

### Example 7

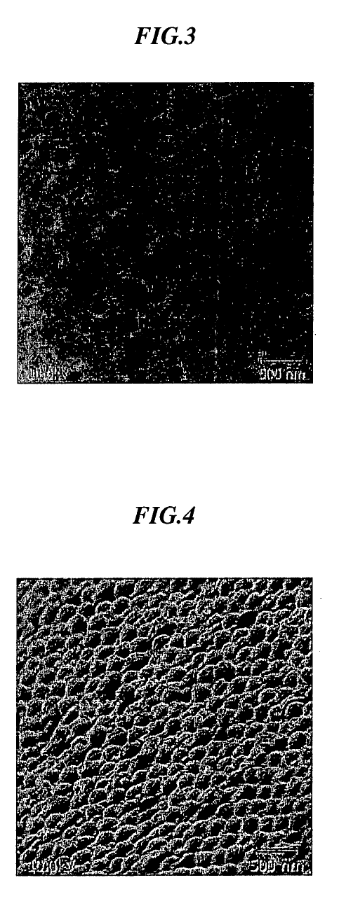

20 mg of a 40 wt % dispersion of core-shell particles comprising a core portion having a core diameter of about 310 nm made of polystyrene and a shell portion having a thickness of about 10 nm made of crosslinked poly(N-isopropylacrylamide)-acrylic acid in a state of being dispersed in water prepared in the same manner as in Example 1 was applied onto the bottom of a sample bottle, followed by the addition of 0.1 ml of tetramethyl orthosilicate (tetramethoxysilane: TMOS) and further standing for 10 minutes. After removing the supernatant and drying for one day, a thin film of a three-dimensional periodic structure was formed on the bottom of the bottle. The resulting thin film showed an iridescence color. The resulting thin film was peeled off, washed by dipping in toluene for 30 minutes and dried, and then the cross-section was observed by an electron microscope. As shown in FIG. 3, it was confirmed that the thin film is made of a three-dimensional periodic structure having an inverse opal structure in which the core portion is removed.

### Example 8

In 100 ml of water, 0.5 g of N-isopropylacrylamide and 3.5 g of styrene were added and core particles were prepared under a nitrogen gas flow at 70° C. using potassium persulfate (KPS(K₂S₂O₈)) as an initiator. Furthermore, 0.7 g of N-isopropylacrylamide and 0.07 g of N,N′-methylenebisacrylamide were added and a shell portion was formed using KPS as an initiator to prepare core-shell particles comprising a core portion made of polystyrene and a shell portion made of crosslinked poly(N-isopropylacrylamide). In the same manner as in Example 2, an average particle size was determined. The resulting particles showed a thickness of the shell portion in a state of being dispersed in water of about 20 nm and an average core particle size of 310 nm. 20 mg of a 40 wt % dispersion was applied onto the bottom of a sample bottle, followed by the addition of 0.1 ml of tetraethyl orthosilicate (tetraethoxysilane: TEOS) and further standing for 10 minutes. After removing the supernatant and drying for one day, a thin film of a three-dimensional periodic structure was formed on the bottom of the bottle. The resulting thin film showed an iridescence color. The resulting thin film was peeled off and the cross-section was observed by an electron microscope. As shown in FIG. 4, a three-dimensional periodic structure having an internal structure in which fine particles are periodically arranged was confirmed. The resulting thin film showed an iridescence color. The resulting thin film was peeled off, washed by dipping in toluene for 30 minutes and dried, and then the cross-section was observed by an electron microscope. As shown in FIG. 5, it was confirmed that the thin film is made of a three-dimensional periodic structure having an inverse opal structure in which the core portion is removed.

### Example 9

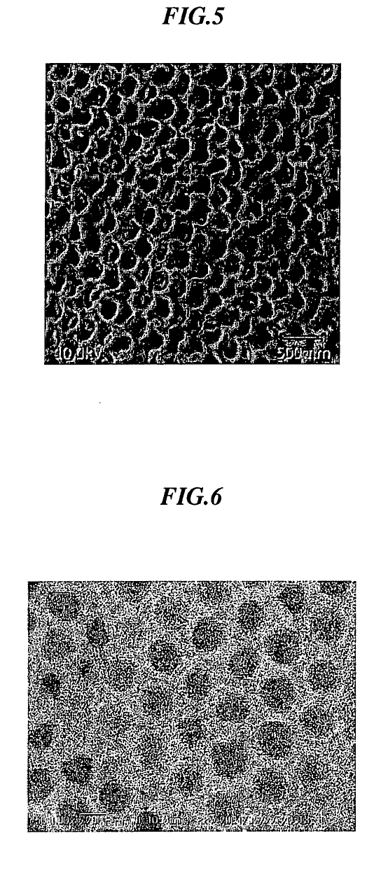

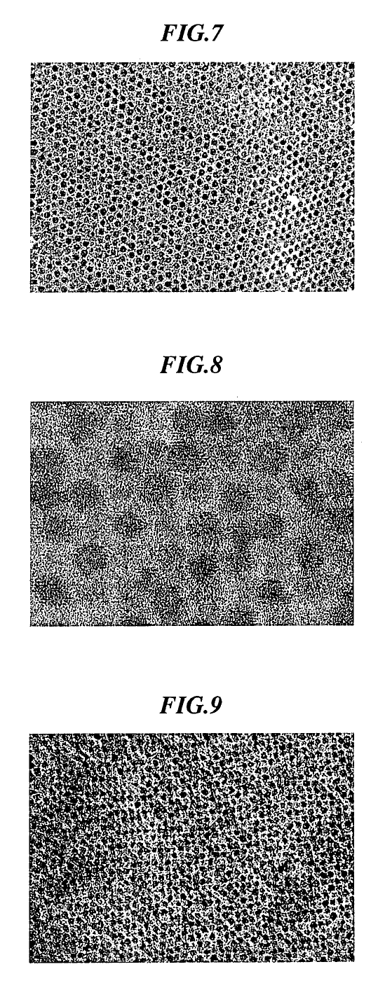

In 300 ml of water, 1.54 g of N-isopropylacrylamide and 10.1 g of styrene were added and core particles were prepared under a nitrogen gas flow at 70° C. using potassium persulfate (KPS(K₂S₂O₈)) as an initiator. An average particle size of the resulting particles was measured by a particle analyzer capable of measuring over a wide concentration range, “FPAR-1000” manufactured by Otsuka Electronics Co., Ltd. As a result, it was 380 nm. Furthermore, 2.11 g of N-isopropylacrylamide and 0.22 g of N,N′-methylenebisacrylamide were dissolved in 100 ml of water and core-shell particles comprising a core portion made of polystyrene and a shell portion made of crosslinked poly(N-isopropylacrylamide) was prepared by using KPS as an initiator, and an average particle size of the resulting core-shell particles was measured by a particle analyzer capable of measuring over a wide concentration range, “FPAR-1000” manufactured by Otsuka Electronics Co., Ltd. As a result, an average particle size of core-shell particles in a state of being dispersed in water was found to be about 540 nm and an average thickness of the shell portion was found to be about 80 nm. A 25 wt % dispersion of the resulting core-shell particles was spin-coated on a slide glass, and then the coated slide glass was dipped in tetraethyl orthosilicate (tetraethoxysilane: TEOS) and allowed to stand for 12 hours. The substrate was taken out, washed with hexane and then sintered in an electric furnace at 700° C. for 2 hours. As a result, an inorganic oxide film having an iridescence color, which shows metal gloss, was obtained. The cross-section of the film was observed by a scanning electron microscope (manufactured by KEYENCE CORPORATION under the trade name of “VE-7800”). As shown in FIGS. 6 and 7, it was confirmed that the thin film is made of a periodic structure in which pores are not connected with each other and independent pores are periodically arranged. The periodic structure showed an average pore size of 260 nm, center-distance of pores of 350 nm, and a thickness of an inorganic oxide on a line connecting the centers of adjacent pores of 90 nm.

### Example 10

A film made of an inorganic oxide periodic structure obtained in Example 9 was dipped in an aqueous sodium hydroxide solution (0.1 mol/l) for 5 hours and, after taking out, the surface was observed. As a result, as shown in FIGS. 8 and 9, it was confirmed that independent pores of the inorganic oxide periodic structure were maintained over the entire sample and resistance to an alkali.

### Example 11

20 mg of a dispersion (25 wt % water dispersion) of core-shell particles prepared in the same manner as in Example 9 was applied onto the bottom of a sample bottle having an inner diameter of 25 mm, followed by the addition of 0.1 ml of tetraethyl orthosilicate (tetraethoxysilane: TEOS) and further standing for 30 minutes. After removing the supernatant and standing for one week while putting on a lid, the lid was taken off, followed by drying for one day to form a thin film of a three-dimensional periodic structure on the bottom of the bottle. The resulting thin film showed an iridescence color. This thin film was sintered in an electric furnace at 700° C. for 2 hours. As a result, an inorganic oxide film having an iridescence color, which shows metal gloss, was obtained. The cross-section of the film was observed by a scanning electron microscope. As a result, it was confirmed that the film is made of a periodic structure in which pores are not connected with each other and independent pores are periodically arranged. The periodic structure showed an average pore size of 260 nm, center-distance of pores of 350 nm, and a thickness of an inorganic oxide on a line connecting the centers of adjacent pores of 90 nm.

### Example 12

20 mg of a dispersion (25 wt % water dispersion) of core-shell particles prepared in the same manner as in Example 9 was applied onto the bottom of a sample bottle having an inner diameter of 25 mm, followed by the addition of 0.1 ml of tetramethyl orthosilicate (tetramethoxysilane: TMOS) and further standing for 30 minutes. After standing for one week while putting on a lid, the lid was taken off, followed by drying for one day to form a thin film of a three-dimensional periodic structure on the bottom of the bottle. The resulting thin film showed an iridescence color. This thin film was sintered in an electric furnace at 700° C. for 2 hours. As a result, an inorganic oxide film having an iridescence color, which shows metal gloss, was obtained. The cross-section of the film was observed by a scanning electron microscope. As a result, it was confirmed that the film is made of a periodic structure in which pores are not connected with each other and independent pores are periodically arranged. The periodic structure showed an average pore size of 260 nm, center-distance of pores of 350 nm, and a thickness of an inorganic oxide on a line connecting the centers of adjacent pores of 90 nm.

### Example 13

A dispersion (50% by weight water dispersion) of core-shell particles prepared in the same manner as in Example 9 was spin-coated on a slide glass, and then the spin-coated slide glass was dipped in titanium (IV) tetra butoxide and allowed to stand for one hour. The substrate was taken out, washed with hexane and then sintered in an electric furnace at 700° C. for 2 hours. As a result, an inorganic oxide film having an iridescence color, which shows metal gloss, was obtained. The cross-section of the film was observed by a scanning electron microscope. As a result, it was confirmed that the film is made of a periodic structure in which pores are not connected with each other and independent pores are periodically arranged.

### Example 14

In 800 ml of water, 4 g of N-isopropylacrylamide and 24 g of styrene were added and core particles were prepared under a nitrogen gas flow at 80° C. using potassium persulfate (KPS(K₂S₂O₈)) as an initiator. An average particle size of the resulting particles was measured by a particle analyzer capable of measuring over a wide concentration range, “FPAR-1000” manufactured by Otsuka Electronics Co., Ltd. As a result, it was 240 nm. Furthermore, 100 ml of water containing 2.5 g of N-isopropylacrylamide and 0.25 g of N,N′-methylenebisacrylamide dissolved therein was added and core-shell particles comprising a core portion made of polystyrene and a shell portion made of crosslinked poly(N-isopropylacrylamide) was prepared by using KPS as an initiator.

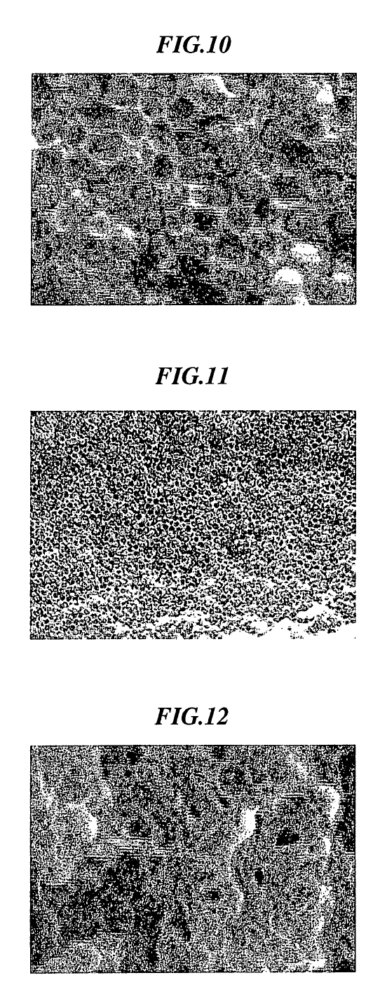

In the same manner, an average particle size of the resulting core-shell particles (1) was measured by a particle analyzer capable of measuring over a wide concentration range, “FPAR-1000” manufactured by Otsuka Electronics Co., Ltd. As a result, an average particle size of core-shell particles in a state of being dispersed in water was found to be about 840 nm and a thickness of the shell portion was found to be about 200 nm. A 15 wt % dispersion of the resulting core-shell particles was spin-coated on a slide glass, and then the coated slide glass was dipped in tetraethyl orthosilicate (tetraethoxysilane: TEOS) and allowed to stand for 12 hours. The substrate was taken out, washed with hexane and then sintered in an electric furnace at 700° C. for 2 hours. As a result, an inorganic oxide film, which shows metal gloss, was obtained. The cross-section of the film was observed by a scanning electron microscope. As a result, as shown in FIG. 10, it was confirmed that the thin film is made of a periodic structure in which pores are not connected with each other and independent pores are periodically arranged. The periodic structure showed an average pore size of 200 nm, center-distance of pores of 330 nm, and a thickness of an inorganic oxide on a line connecting the centers of adjacent pores of 130 nm.

### Example 15

In the same manner as in Example 14, a 15 wt % dispersion of core-shell particles comprising a core portion having a core diameter of about 240 nm made of polystyrene and a shell portion having a thickness of about 200 nm made of crosslinked poly(N-isopropylacrylamide) in a state of being dispersed in water was applied onto a glass substrate measuring 2.5 cm×2.5 cm using a spin coating method, dipped in 9 ml of tetraethyl orthosilicate (tetraethoxysilane: TEOS) and then allowed to stand for 12 hours. The glass plate was taken out, dipped in tetramethyl orthosilicate (tetramethoxysilane: TMOS) and then allowed to stand for one hour. The substrate was washed with hexane and then sintered in an electric furnace at 700° C. for 2 hours to obtain an inorganic oxide film which shows metal gloss. The film was peeled off and the cross-section of the film was observed by a scanning electron microscope. As a result, it was confirmed that the thin film is made of a periodic structure in which pores are not connected with each other and independent pores are periodically arranged. The periodic structure showed an average pore size of 200 nm, center-distance of pores of 330 nm, and a thickness of an inorganic oxide of 130 nm.

### Comparative Example 1

In 300 ml of water, 1.54 g of N-isopropylacrylamide and 10.1 g of styrene were added and particles having an average particle size of 380 nm were prepared under a nitrogen gas flow at 70° C. using potassium persulfate (KPS(K₂S₂O₈)) as an initiator. A dispersion of fine particles was sedimented by a centrifugal separator and then dried. The resulting dry sediment was ground and spread over a filter paper placed on a Kiriyama Glass Works' funnel, and then a solution mixture of ethanol and tetraethyl orthosilicate (tetraethoxysilane: TEOS) was added dropwise via the powder under suction. Dropwise addition of the solution mixture was terminated after wetting the entire powder, and the powder was dried overnight and vacuum-dried for 2 hours. Using an electric furnace, the powder was sintered at 700° C. for 2 hours to obtain a dark brown powder, a portion of which shows a violet color.

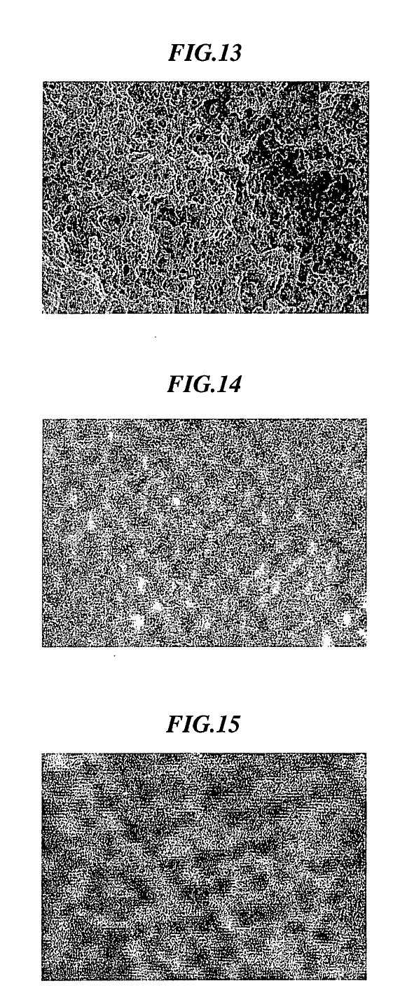

The cross-section of the powder was observed by a scanning electron microscope (manufactured by KEYENCE CORPORATION under the trade name of “VE-7800”). As a result, it was confirmed that pores connecting with pores are arranged at the violet portion as shown in FIGS. 11 and 12. As shown in FIGS. 13 and 14, the dark brown portion is formed of a pore-free continuous material and a non-uniform inorganic oxide structure is observed.

### Comparative Example 2

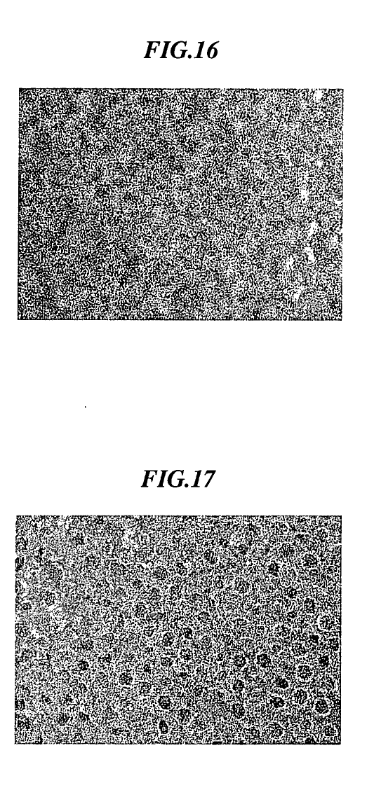

The inorganic oxide prepared in Comparative Example 2 was dipped in an aqueous sodium hydroxide solution (0.1 mol/l) for 5 hours and, after taking out, the surface was observed. As a result, as shown in FIGS. 15, 16 and 17, the distance between pores drastically decreases and a structure varies with the portions, for example, the portion where a periodic structure of connecting pores is maintained (FIG. 15), the portion where a periodic structure is destroyed (FIG. 16) and the portion where no periodic structure is observed (FIG. 17). Thus, it was confirmed that the structure was easily destroyed by an alkali.

As described above, in the three-dimensional periodic structures and the three-dimensional periodic porous structures obtained in Examples 1 to 8, fine particles or pores have a uniform structure in which independent pores are arranged with three-dimensional periodicity, and the distance between these fine particles or pores could be controlled according to the thickness of the shell portion. These structures showed a structural color according to the particle size, the pore size, and the distance between particles or pores. Also a three-dimensional periodic structure made of an inorganic oxide exhibited excellent chemical resistance.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description but is only limited by the scope of the appended claims.

What is claimed is:

1. A method for producing a three-dimensional periodic structure, comprising the steps of:
(1) dispersing core-shell particles in an aqueous solvent to obtain a dispersion, the core-shell particles each comprising a core portion made of a fine particle and a shell portion made of a crosslinked hydrophilic organic polymer backbones, and
(2) adding metal alkoxides to the dispersion thereby to cause a sol-gel reaction of the metal alkoxides producing a structure in which the fine particles of the core portions are arranged with three-dimensional periodicity in a composite comprising the crosslinked hydrophilic organic polymer backbones and inorganic oxides produced by the sol-gel reaction of the metal alkoxides, which are integrated with each other.

2. The method for producing a three-dimensional periodic structure according to claim 1, wherein the metal alkoxide is selected from alkoxy silane and titanium alkoxide.

3. The method for producing a three-dimensional periodic structure according to claim 1, wherein a concentration of the core-shell particles in the dispersion in the step (1) is within a range from 15 to 60% by mass with respect to the dispersion.

4. The method for producing a three-dimensional periodic structure according to claim 1, wherein an amount of the metal alkoxides to be added in the step (2) is the same as or more than a volume amount of the dispersion.

5. A method for producing a three-dimensional periodic porous structure, comprising the steps of:
(i) dispersing core-shell particles in an aqueous solvent to obtain a dispersion, the core-shell particles each comprising a core portion made of a fine particle of an organic polymer compound and a shell portion made of a crosslinked hydrophilic organic polymer backbones,
(ii) adding a metal alkoxide to the dispersion thereby to cause a sol-gel reaction of the metal alkoxides producing a structure in which the fine particles of the core portions are arranged with three-dimensional periodicity in a composite material comprising the crosslinked hydrophilic organic polymer backbones and an inorganic oxide produced by the sol-gel reaction of the metal alkoxides, which are hybridized into organic/inorganic domain, and
(iii) removing the fine particles in the structure.

6. The method for producing a three-dimensional periodic porous structure according to claim 5, wherein the removal of the fine particles in the step (iii) is conducted by sintering at a temperature within a range from 600 to 1500° C.

7. The method for producing a three-dimensional periodic porous structure according to claim 5, wherein the removal of the fine particles in the step (iii) is conducted by eluting with a solvent.
